(19) United States
(12) Patent Application Publication
(10) Pub. No.: US 2022/0070058 A1
(43) Pub. Date: Mar. 3, 2022

(54) CONNECTION DEVICE

(71) Applicant: PEGATRON CORPORATION, Taipei City (TW)

(72) Inventors: Ming-Hung LEE, Taipei City (TW); Sheng-Yao CHENG, Taipei City (TW); Shu-Hao WU, Taipei City (TW)

(21) Appl. No.: 17/400,826

(22) Filed: Aug. 12, 2021

(30) Foreign Application Priority Data
Aug. 28, 2020 (TW) 109129452

(51) Int. Cl. H04L 12/24

(52) U.S. Cl. CPC H04L 41/0803

(57) ABSTRACT

The present invention provides a connection device which is adapted to be connected between an electronic device and a host-side device. The connection device includes: a plurality of transmission ports, where one of the transmission ports is connected to an electronic device; a memory storing a lookup table; and a controller electrically connected to the transmission ports and the memory and configured to receive a configuration instruction, where the configuration instruction includes a first field and a second field, the first field records a transmission format index value, and the second field records selection information, where the controller searches the lookup table according to the transmission format index value to obtain a connection transmission format, selects corresponding at least one of the transmission ports from the plurality of transmission ports according to the selection information, and performs configuration setting on the electronic device according to the connection transmission format.

### CROSS-REFERENCE TO RELATED APPLICATION

This application claims priority to Taiwan Application Serial Number 109129452, filed on Aug. 28, 2020, which is herein incorporated by reference in its entirety.

### BACKGROUND

### Technical Field

The present invention relates to a device, and in particular, to a connection device.

### Related Art

In the prior art, if a host-side device needs to perform communication operations such as writing or reading with electronic devices with different transmission formats, in addition to needing to dispose a transmission port on hardware, the host-side device further needs to adaptively provide corresponding communication instructions based on the different transmission formats of the electronic devices. In this way, burdens of the host-side device on communication are caused.

### SUMMARY

The present invention provides a connection device to integrate a host-side device to be connected to a plurality of electronic devices with different transmission formats.

The connection device of the present invention is adapted to be connected between an electronic device and a host-side device. The host-side device generates, according to a host-side lookup table stored in the host-side device, a configuration instruction for communication. The connection device includes a plurality of transmission ports, a memory, and a controller. The transmission ports are adapted to be connected to the electronic device. The memory stores a lookup table, where the lookup table records a plurality of transmission format numbers, and the transmission format numbers respectively correspond to transmission formats. The controller electrically connects the transmission ports to the memory. When at least one of the plurality of transmission ports is connected to the host-side device and the electronic device, and the controller receives a configuration instruction from the host-side device, where the configuration instruction includes a first field and a second field, the first field records a transmission format index value, and the second field records selection information, where the controller searches the lookup table according to the transmission format index value to obtain a connection transmission format from the transmission formats, selects corresponding at least one of the transmission ports from the transmission ports according to the selection information, and performs configuration setting on the electronic device according to the connection transmission format.

The connection device of the present invention is adapted to be connected between an electronic device and a host-side device. The host-side device generates, according to a host-side lookup table stored in the host-side device, a configuration instruction for communication. The connection device includes a plurality of transmission ports, a memory, and a controller. The transmission ports are adapted to be connected to the electronic device. The memory stores a lookup table, where the lookup table records a plurality of transmission numbers and a plurality of transmission functions, and the transmission numbers respectively correspond to the transmission functions. The controller electrically connects the transmission ports to the memory. When at least one of the plurality of transmission ports connects the host-side device to the electronic device, the controller receives the transmission instruction from the host-side device to communicate with the electronic device. The transmission instruction includes a header field and a first field. The header field records a transmission index value. The first field records transmission information, and the controller queries the lookup table according to the transmission index value to obtain a connection transmission function from the transmission functions, and communicates with the electronic device through the connection transmission function according to content of the transmission information.

Based on the above, the connection device can effectively integrate the connection between the host-side device and the electronic devices with a plurality of different transmission formats, and a single connector may be used to connect the electronic devices with different transmission formats, so as to effectively integrate the plurality of different transmission formats during communication between the host-side device and the electronic device, thereby improving compatibility of the host-side device.

### BRIEF DESCRIPTION OF THE DRAWINGS

FIG. 1 is a schematic diagram of a connection device according to an embodiment of the present invention.

FIG. 2A is a schematic diagram of a configuration instruction received by a connection device according to an embodiment of the present invention.

FIG. 2B is a schematic diagram of the configuration instruction received by a connection device according to an embodiment of the present invention.

FIG. 2C is a schematic diagram of the configuration instruction received by a connection device according to an embodiment of the present invention.

FIG. 3A is a schematic diagram of a transmission instruction received by a connection device according to an embodiment of the present invention.

FIG. 3B is a schematic diagram of the transmission instruction received by a connection device according to an embodiment of the present invention.

FIG. 3C is a schematic diagram of the transmission instruction received by a connection device according to an embodiment of the present invention.

### DETAILED DESCRIPTION

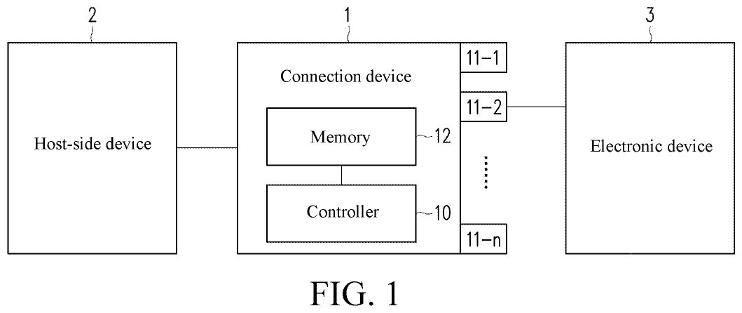

FIG. 1 is a schematic diagram of a connection device 1 according to an embodiment of the present invention. The connection device 1 includes a controller 10, a plurality of transmission ports 11-1 to 11-n, and a memory 12. The connection device 1 is connected between a host-side device 2 and an electronic device 3. A transmission port 11-2 of the transmission ports 11-1 to 11-n of the connection device 1 is connected to the electronic device 3. Generally, the connection device 1 connects the host-side device 2 to the electronic device 3. In this way, the host-side device 2 may have different operating systems, and the electronic device 3 may have different transmission specifications, so that the connection device 1 can integrate the host-side device 2 from different operating systems to communicate with the electronic device 3. In an embodiment, according to the transmission specifications of the electronic device 3, the connection device 1 may be selectively connected to the electronic device 3 through the transmission port 11-2 of the transmission ports 11-1 to 11-n accordingly, so that the host-side device 2 is connected to the electronic device 3 through the connection device 1. Further, in order to communicate with the electronic device 3 of different transmission specifications, the controller 10 of the connection device 1 can receive an instruction from the host-side device 2 to communicate with the electronic device 3. Although the host-side device 2 and the connection device 1 shown in FIG. 1 are arranged as separate structures, the host-side device 2 and the connection device 1 may also be integrated into a single structure, which also belongs to the scope of the present invention.

The connection device 1 may be connected to the host-side device 2 and the electronic device 3, so that the host-side device 2 and the electronic device 3 can communicate with each other. The connection device 1 may include, but is not limited to, for example, a universal serial bus (USB) hub, as long as the connection device 1 can be connected between a host-side device and an electronic device, and provides a connection transmission function between the host-side device and the electronic device.

The controller 10 of the connection device 1 may receive at least one configuration instruction from the host-side device 2 to perform configuration setting for the electronic device 3, and then receive a transmission instruction from the host-side device 2 to communicate with the electronic device 3. In detail, the configuration instruction provided by the host-side device 2 may correspond to a specific connection transmission format, and the controller 10 may read the configuration instruction to enable or disable the electronic device 3 with the connection transmission format or perform configuration setting of other functions. Then, upon completion of the configuration setting, the host-side device 2 may provide a transmission instruction to a specific transmission port (for example, the transmission port 11-2), and the connection device 1 may read the transmission instruction to communicate with the electronic device 3 connected to the transmission port through writing or reading. According to different design requirements, a number of transmission ports connected to the electronic device 3 may be adaptively increased, so that the electronic device 3 can be connected to the host-side device 2 through at least one transmission port of the connection device 1. Therefore, the connection device 1 may be connected between the host-side device 2 and the electronic device 3, so that the host-side device 2 can communicate with the electronic device 3 of different transmission specifications to improve hardware compatibility between different transmission specifications. Further, the host-side device 2 may provide a signal to the connection device 1 according to a human interface device (HID) transmission protocol of the universal serial bus, so as to provide a signal packet conforming to the above transmission protocol to the connection device 1 to communicate with the electronic device 3.

The controller 10 may be designed through a hardware description language (HDL) or any other digital circuit design method well known to those with ordinary knowledge in the art, and a hardware circuit implemented through a field programmable gate array (FPGA), a complex programmable logic device (CPLD), or an application-specific integrated circuit (ASIC). Alternatively, the controller 10 may include a central processing unit (CPU), or other programmable general-purpose or special-purpose micro control unit (MCU), a microprocessor, a digital signal processor (DSP), a programmable controller, an application-specific integrated circuit (ASIC), a graphics processing unit (GPU), an arithmetic logic unit (ALU), a complex programmable logic device (CPLD), a field programmable gate array (FPGA), or other similar elements or a combination of the above elements.

The transmission specifications of the transmission ports 11-1 to 11-n may include but are not limited to, for example, a general-purpose input/output (GPIO) format, an inter-integrated circuit bus (I²C) format, a pulse width modulation (PWM) format, a serial peripheral interface (SPI) format, and an analog to digital converter (ADC) format. Therefore, the connection device 1 can be connected to the electronic device 3 of different transmission specifications through the transmission ports 11-1 to 11-n.

The memory 12 stores a lookup table, where the lookup table may store a plurality of transmission format numbers and a plurality of transmission formats, and the transmission format numbers respectively correspond to the transmission formats. The controller 10 may query the lookup table according to a transmission format index value included in the configuration instruction. In other words, the controller 10 can select the transmission format number corresponding to the transmission format index value by comparing the transmission format index value with the transmission format number, and the corresponding transmission format is selected from the transmission format as the connection transmission format according to the corresponding transmission format number. The memory 12 may include, but is not limited to, for example, any type of fixed or removable random access memory (RAM), a read-only memory (ROM), a flash memory, a hard disk drive (HDD), a solid state drive (SSD), or a similar element, or a combination of the above elements.

The host-side device 2 may include, but is not limited to, for example, a mobile station, an advanced mobile station (AMS), a server, a client, a desktop computer, a notebook computer, a network computer, a workstation, a personal digital assistant (PDA), a personal computer (PC), a tablet computer, a scanner, a telephone device, a pager, a camera, a TV, a handheld game console, a music device, a wireless sensor, or the like. In an embodiment, in order to provide a configuration instruction and/or a transmission instruction to the electronic device 3 to communicate with the host-side device 2, the host-side device 2 may also store a corresponding host-side lookup table, so that the host-side device 3 can preferably provide the configuration instruction and/or the transmission instruction to the connection device 1.

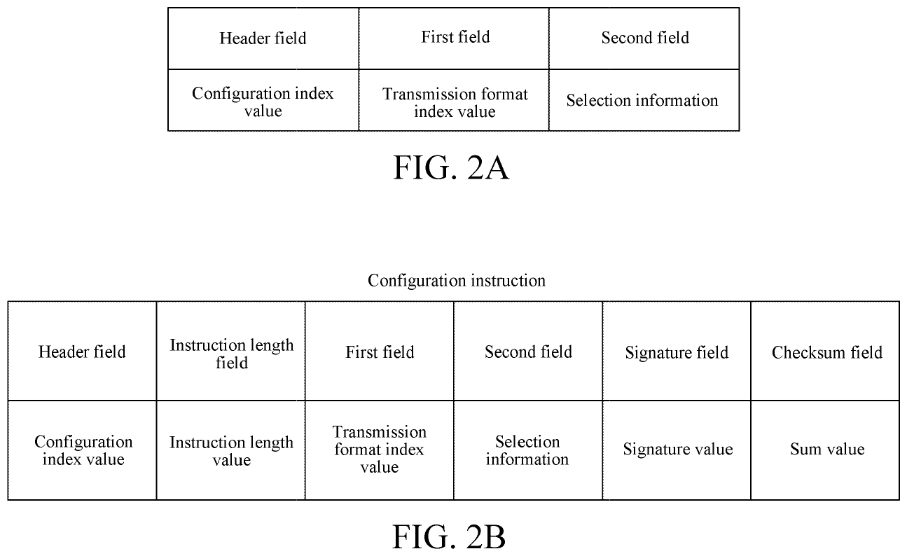

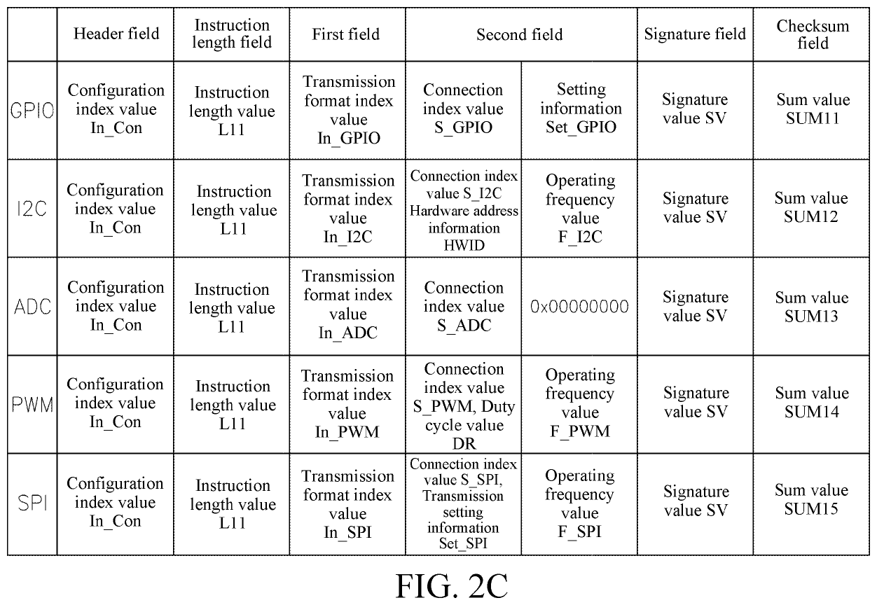

Regarding the configuration instruction received by the connection device 1, referring to FIG. 2A, FIG. 2A is a schematic diagram of a configuration instruction received by a connection device 1 according to an embodiment of the present invention. The configuration instruction includes a header field, a first field, and a second field. The header field can record a configuration index value of the configuration instruction, and the controller 10 can read the configuration index value of the header field to identify the received instruction as a configuration instruction to read information in the subsequent first field. The first field may record the transmission format index value, and the controller 10 may determine the format of the overall configuration instruction according to the transmission format index value. In other words, the controller 10 can compare the transmission format index value with the transmission format number stored in the memory to select the connection transmission format, and then determine the connection transmission format corresponding to the configuration instruction and the packet structure of the configuration instruction to read information in the subsequent second field in the configuration instruction.

The second field may record selection information, the controller 10 may select one or more transmission ports according to the selection information, and configuration setting is performed for one or more connected electronic devices 3. For ease of understanding, FIG. 1 only shows that the connection device 1 is connected to one electronic device 3, but the present invention is not limited thereto. Definitely, the connection device 1 can be connected to a plurality of electronic device 3 simultaneously through the corresponding transmission ports 11-1 to 11-n, and configuration setting and communication are performed for the one or more connected electronic devices 3 according to the configuration instruction provided by the host-side device 2.

In detail, referring to FIG. 2B, FIG. 2B is a schematic diagram of the configuration instruction received by a connection device 1 according to another embodiment of the present invention. In this embodiment, in addition to the header field, the first field, and the second field, the configuration instruction may additionally include an instruction length field, a signature field, and a checksum field. Regarding the content recorded in the header field, the first field, and the second field, reference may be made to the above relevant paragraphs, and details are not described herein again. In detail, the instruction length field may record an instruction length value, so that the controller 10 can obtain a length of the configuration instruction accordingly. The signature field may record a signature value, and the controller 10 verifies, according to the signature value, the host-side device 2 that sends the configuration instruction. The checksum field records a sum value, which may be a sum value generated by adding up all data in the configuration instruction. The controller 10 may perform operations such as checking and debugging for the received configuration instruction according to the sum value.

Further, referring to FIG. 2C, FIG. 2C is a schematic diagram of the configuration instruction received by a connection device 1 according to another embodiment of the present invention. FIG. 2C exemplarily lists packet formats of configuration instructions provided by the host-side device 2 for different transmission specifications. In this embodiment, the host-side device 2 may provide configuration instructions for different connection transmission formats such as a GPIO format, an I2C format, an ADC format, a PWM format, an SPI format, and the like. Configuration instructions of different transmission specifications may have the same configuration index value In_Con. Therefore, the controller 10 may identify the received instruction as the configuration instruction according to the configuration index value In_Con. For example, the configuration index value In_Con may be 0x43 and have a length of one byte. The configuration instructions of different transmission specifications may also have the same instruction length value L11, so that the lengths of the configuration instructions of different transmission specifications can be unified, which is convenient for the controller 10 to read. For example, the instruction length value L11 may record that the length of the configuration instruction is 22 bytes, and the instruction length value L11 itself has the length of one byte.

In the first field, different connection transmission formats may correspond to different transmission format index values. The controller 10 may determine detailed packet formats of the configuration instructions accordingly. For example, the transmission format index value In_GPIO may be 0x47; the transmission format index value In_I2C may be 0x69; the transmission format index value In PWM may be 0x50; the transmission format index value In SPI may be 0x03, and the transmission format index value In_GPIO, the transmission format index value In_I2C, the transmission format index value In_PWM, and the transmission format index value In_SPI may have the same length of four bytes. The controller 10 may query the lookup table according to the transmission format index value to determine the connection transmission format corresponding to the configuration instruction.

The second field may include corresponding configuration setting information according to different transmission specifications. For example, when the configuration instruction is configured for the GPIO format, the selection information may include a connection index value S_GPIO and setting information Set_GPIO. The controller 10 may respectively transmit enable or disable signals to the thirteen GPIO transmission ports in the output ports 11-1 to 11-n according to the connection index value S_GPIO. The controller 10 respectively sets the electronic devices connected to the thirteen GPIO transmission ports to an input state or an output state according to the setting information Set_GPIO. In this example, the connection index value S_GPIO may have a length of four bytes, in which first thirteen bits may respectively correspond to different GPIO transmission ports, and the controller 10 may separately enable or disable each of the GPIO transmission ports according to the connection index value S_GPIO. The setting information Set_GPIO may have a length of four bytes, in which first thirteen bits may respectively correspond to different GPIO transmission ports, and the controller 10 may respectively set the electronic devices connected to the GPIO transmission ports to an input state or an output state according to the setting information Set_GPIO.

When the configuration instruction is configured for the I2C format, the selection information may include a connection index value S_I2C, hardware address information HWID, and an operating frequency value F_I2C. The controller 10 may select, from two I2C transmission ports of the output ports 11-1 to 11-n according to the connection index value S_I2C, one transmission port connected to the electronic device 3. The controller 10 may connect a storage device (for example, a physical address of an electronic erasable rewritable read-only memory) of the electronic device 3 according to the hardware address information HWID to read or write to the storage device. The controller 10 may set a frequency during communication in the I2C format according to the operating frequency value F_I2C. In this example, the hardware address information HWID and the connection index value S_I2C may have a total length of four bytes, in which first eight bits may record the hardware address information HWID, and the seventeenth and eighteenth bits may record the connection index value S_I2C. In addition, the operating frequency value F_I2C may have a length of four bytes, and the operating frequency value F_I2C may record values between 0 and 0x190 to correspondingly represent the operating frequency values of 0 to 400 kHz.

When the configuration instruction is configured for the ADC format, the selection information may include the connection index value S_ADC and blank data (that is, four-byte length data 0x00000000), and the controller 10 may select one transmission port from eight ADC transmission ports in the output ports 11-1 to 11-n according to the connection index value S_ADC. In this example, the connection index value S_I2C may have a length of four bytes, in which first eight bits may correspond to the respective ADC transmission ports.

When the configuration instruction is configured for the PWM format, the selection information may include a connection index value S_PWM, a duty cycle value DR, and an operating frequency value F_PWM. The controller 10 may select one from four PWM transmission ports of the output ports 11-1 to 11-n according to the connection index value S_PWM. In this example, the duty cycle value DR and the connection index value S_PWM may have a total length of four bytes, in which first seven bits may record values between 0 and 0x64 to correspondingly represent a duty cycle of 0% to 100%, and the seventeenth bit to the twentieth bit may respectively correspond to the four PWM transmission ports, so that the controller 10 can select one of the transmission ports accordingly. The operating frequency value F_PWM may have a length of four bytes, and may record a value between 0x0000000A and 0x000F4240 to correspondingly represent the operating frequency between 10 and 1 MHz.

When the configuration instruction is configured for the SPI format, the selection information may include a connection index value S_SPI, transmission setting information Set_SPI, and an operating frequency value F_SPI. The controller 10 may select one from two SPI transmission ports of the output ports 11-1 to 11-n according to the connection index value S_SPI. The controller 10 may determine information such as a trigger mode, a signal width (data width), master-slave setting, and the like for transmission according to the transmission setting information Set_SPI. In this example, the connection index value S_SPI and the transmission setting information Set_SPI may have a total length of four bytes, in which first two bits may record the trigger mode of the PWM format, the tenth to fifteenth bits may record values between 0 and 0x20 to correspond to the signal width from 0 to 32 bits, the sixteenth bit may record master-slave setting information, and the seventeenth to eighteenth bits may separately record selection information corresponding to the two SPI transmission ports. The operating frequency value F_SPI may have a length of four bytes, and may record a value between 0 and 0x044AA200 to correspondingly represent the operating frequency between 0 and 72 MHz.

In the signature field, configuration instructions of different connection transmission formats may have the same signature value SV, so that the controller 10 can read the signature value for verification. For example, the signature value SV may have a length of four bytes, and may be 0x61676550. In the checksum field, sum values SUM11 to SUM15 of the four-byte length may be recorded. The sum values SUM11 to SUM15 respectively record a sum obtained by adding up data of each configuration instruction, so that the controller 10 can perform operations such as checking and debugging for each configuration instruction according to the sum values SUM11 to SUM15.

Therefore, the connection device 1 may receive a configuration instruction of a uniform format provided by the host-side device 2 to configure the electronic device 3 according to the control of the host-side device 2. In other words, the host-side device 2 can use the configuration instruction of a single signal format and the configuration settings through the connection device 1 to connect electronic devices with different connection transmission formats., so as to effectively integrate the plurality of different connection transmission formats during communication between the host-side device 2 and the electronic device 3, thereby improving compatibility of the host-side device 2.

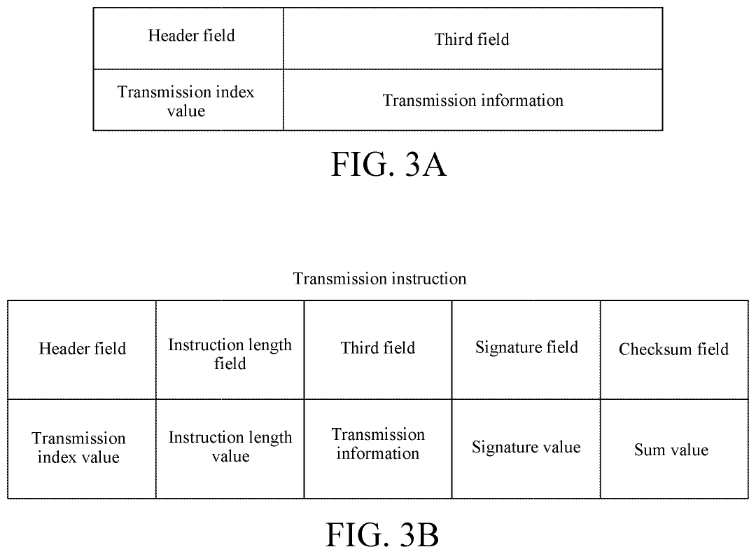

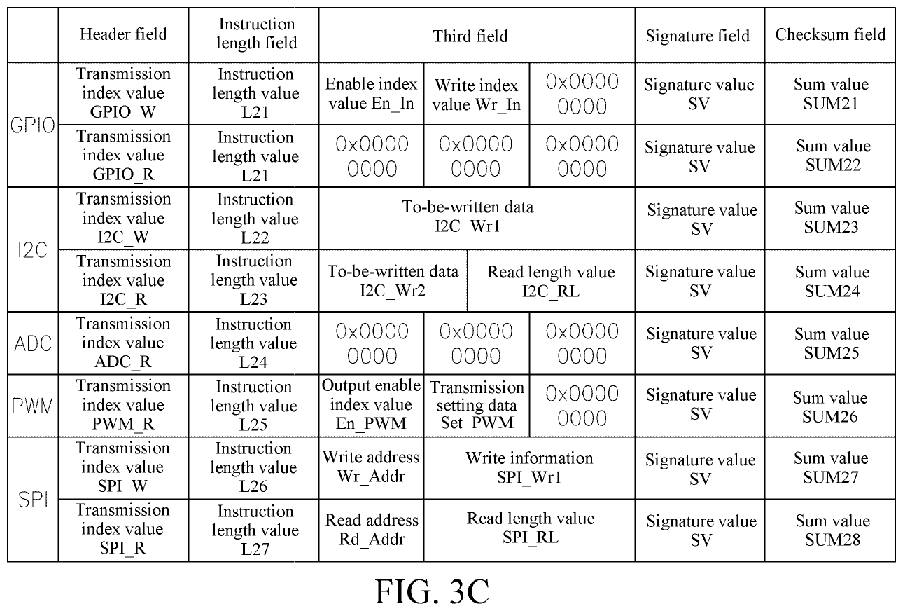

FIG. 3A is a schematic diagram of a transmission instruction received by a connection device 1 according to an embodiment of the present invention. In an embodiment, the host-side device 2 may continue to provide a transmission instruction to the connection device 1 after providing the configuration instruction, so as to perform reading, writing or other communication operations on the electronic device 3. In another embodiment, the host-side device 2 may directly provide a transmission instruction to the connection device 1, so as to perform reading, writing or other communication operations on the electronic device 3. In detail, the transmission instruction includes a header field and a third field. The header field records a transmission index value, and the third field records transmission information. The controller 10 may query the lookup table according to the transmission index value to obtain the transmission command format to determine a packet format of the transmission instruction and a connection transmission function to be performed by the host-side device 2.

Further, the lookup table of the memory 12 of the connection device 1 may store a plurality of transmission numbers and a plurality of transmission functions, and the transmission numbers respectively correspond to the transmission functions. The controller 10 may select the transmission number corresponding to the transmission index value by comparing the transmission index value with the transmission number in the lookup table, and select the corresponding transmission function from the transmission functions as the connection transmission function according to the corresponding transmission number.

In detail, FIG. 3B is a schematic diagram of the transmission instruction received by a connection device 1 according to an embodiment of the present invention. The transmission instruction may include a header field, an instruction length field, a third field, a signature field, and a checksum field. The header field records a transmission index value; the instruction length field records an instruction length value; the third field records transmission information; the signature field records a signature value; and the checksum field records a sum value. For the contents recorded in the header field, the instruction length field, the signature field, and the checksum field, reference is made to the above related description about the header field, the instruction length field, the signature field, and the checksum field in FIG. 2A to FIG. 2C, and details are not described herein again.

FIG. 3C is a schematic diagram of the transmission instruction received by a connection device 1 according to an embodiment of the present invention.

In the header field, each transmission instruction records the transmission index value, so that the controller 10 of the connection device 1 can identify a packet format and a function corresponding to each transmission instruction. For example, when the header field records the transmission index value GPIO_W, I2C_W, or SPI_W, the transmission instruction is respectively for performing a write operation on the electronic device 3 connected to the GPIO, I2C, or SPI transmission ports. When the header field records the transmission index value GPIO_R, I2C_R, ADC_R, PWM_R, and SPI_R, the transmission instruction is respectively for performing a read operation on the electronic device 3 connected to the GPIO, I2C, ADC, PWM, or SPI transmission ports. For example, the transmission index values GPIO_W, GPIO_R, I2C_W, I2C_R, ADC_R, PWM_R, SPI_W, and SPI_R may be 0x47, 0x48, 0x41, 0x69, 0x6A, 0x50, 0x03, 0x04, and all have the length of one byte. In addition, the transmission index values I2C_W, I2C_R, SPI_W, and SPI_R may also be 0x6B, 0x6C, 0x05, and 0x06, respectively, so that the host-side device 2 can perform a read or write operation on the electronic device 3 connected to the I2C or SPI transmission port.

In the instruction length field, the transmission instruction corresponding to the read and write operations in the GPIO format may record the same instruction length value L21, to indicate that the transmission instruction in the GPIO format may be a length of 22 bytes. Other formats corresponding to the I2C format, the ADC format, the PWM format, and the SPI format may have different instruction length values L22-L27, and all instruction length values L21-L27 in the instruction length field may have a length of one bit.

In the third field, when the transmission instruction is for performing a write operation on the electronic device 3 connected to the GPIO transmission port, the third field may record an enable index value En_In or a write index value Wr_In, and the enable index value En_In may have a length of four bytes, and first thirteen bits respectively correspond to thirteen GPIO transmission ports to indicate whether the transmission ports are enabled or disabled. The write index value Wr_In may have a length of four bytes, and first thirteen bits respectively correspond to thirteen GPIO transmission ports, to indicate the GPIO transmission port for the write operation.

When the transmission instruction is for performing a read operation on the electronic device 3 connected to the GPIO transmission port, the third field may only record blank data, and the controller 10 of the connection device 1 performs the read operation on all of the electronic devices 3 connected to the GPIO transmission ports, so that the host-side device 2 reads all of the electronic devices 3 in the GPIO format.

When the transmission instruction is for performing a write operation on the electronic device 3 connected to the I2C transmission port, the third field may record to-be-written data I2C_Wr1, and a data length may vary depending on a length of the written data I2C_Wr1.

When the transmission instruction is for performing a read operation on the electronic device 3 connected to the I2C transmission port, the third field may record to-be-written data I2C_Wr2 or a read length value I2C_RL. Similarly, the data length of the to-be-written data I2C_Wr2 may vary depending on the to-be-written data, and the read length value I2C_RL may have a length of one byte. For example, the to-be-written data I2C_Wr1 and the read length value I2C_RL may have a total length of N bytes. First N-1 bytes are the to-be-written data I2C_Wr2, which may record data to be written, and the last byte is the read length value I2C_RL between 0x01 and 0x36 to respectively indicate that data lengths of the to-be-written data I2C_Wr2 are 1 to 54.

When the transmission instruction is for performing a read operation on the electronic device 3 connected to the ADC transmission port, the third field may only record blank data, which has a length of 12 bytes, so that the electronic device 3 returns the converted data according to the transmission instruction.

When the transmission instruction is for performing a read operation on the electronic device 3 connected to the PWM transmission port, the third field may record an output enable index value En_PWM and transmission setting data Set_PWM. The output enable index value En_PWM may have a length of four bytes, and the first bit of the output enable index value En_PWM may record information that the electronic device 3 is output enabled or output disabled. The transmission setting data Set_PWM may have a length of four bytes, in which first seven bits may record a setting value of a duty cycle, which is between 0 and 0x64 to respectively represent a duty cycle of 0-100%. The seventeenth bit to the twentieth bit respectively store enable or disable information of the four PWM transmission ports.

When the transmission instruction is for performing a write operation on the electronic device 3 connected to the SPI transmission port, the third field may record a write address Wr_Addr or write information SPI_Wr1. The write address Wr_Addr may have a length of four bytes, a first byte of the write address is an instruction code of an SPI format, and the second byte to the fourth byte record address information of twenty-four bits. The write information SPI_Wr1 may record the data to be written by the host-side device 2, and the data length may vary as required.

When the transmission instruction is for performing a read operation on the electronic device 3 connected to the SPI transmission port, the third field may record a read address Rd_Addr or a read length value SPI_RL. The read address Rd_Addr may have a length of four bytes, and the read length value SPI_RL may have a length of one byte. A first byte of the read address Rd_Addr may be an instruction code of an SPI format, and the second byte to the fourth byte record address information of twenty-four bits. The read address Rd_Addr may record a data length value to be read by the host-side device 2.

In the signature field, configuration instructions of different connection transmission formats may have the same signature value SV, so that the controller 10 can read the signature value for verification. For example, the signature value SV may have a length of four bytes, and may be 0x61676550. In the checksum field, sum values SUM21 to SUM28 of the four-byte length may be recorded. The sum values SUM21 to SUM28 respectively record a sum of bit values of each configuration instruction, so that the controller 10 can accordingly perform operations such as checking and debugging.

Further, when the electronic device 3 receives the transmission instruction of the read operation, the electronic device 3 may return data requested by the host-side device 2 to the connection device 1 according to the transmission instruction.

For example, when the electronic device 3 receives a transmission instruction with a transmission index value GPIO_R, the electronic device 3 may return a return instruction in the same format. The return instruction may have a header field, an instruction length field, a third field, a signature field, and a checksum field. The header field may record the transmission index value GPIO_R in the length of one byte. The instruction length field may record the instruction length value L21 in the length of one byte. The third field may record an enabled state value in the length of four bytes, record a write state value in the length of four bytes, and record the blank data in the length of four bytes. The first thirteen bits of the four-byte length record enable state value may respectively correspond to thirteen GPIO transmission ports to separately record whether the electronic device connected to each of the GPIO transmission ports is enabled. The first thirteen bits of the four-byte length record write state value may correspond to the thirteen GPIO transmission ports to separately record whether the electronic device connected to each of the GPIO transmission ports is set to an input state or an output state. The signature field may record the signature value SV in the four bytes. The checksum field may perform summing based on the data of the return instruction to record the sum value corresponding to the return instruction.

For example, when the electronic device 3 receives a transmission instruction with a transmission index value I2C_W, the electronic device 3 may correspondingly provide the return instruction. The return instruction may have a header field, an instruction length field, a third field, a signature field, and a checksum field. The header field may record the transmission index value I2C W in the length of one byte. The instruction length field may record the instruction length value L22 in the length of one byte. The third field may record I2C write information in the length of four bytes, and record the blank data in the length of eight bytes. The four-byte I2C write information may correspond to the written data length value of the transmission instruction, and the data length value may be between 1 and 54. The signature field may record the signature value SV in the four bytes. The checksum field may perform summing based on the data of the return instruction to record the sum value corresponding to the return instruction.

For example, when the electronic device 3 receives a transmission instruction with a transmission index value I2C_R, the electronic device 3 may correspondingly provide the return instruction. The return instruction may have a header field, an instruction length field, a third field, a signature field, and a checksum field. The header field may record the transmission index value GPIO_R in the length of one byte. The instruction length field may record the instruction length value in the length of one byte, and the instruction length value may correspond to the read length value I2C_RL. The third field may record the read data, and the byte length of the read data may be adjusted according to the read length value I2C_RL in the transmission instruction provided by the host-side device 2. The signature field may record the signature value SV in the four bytes. The checksum field may perform summing based on the data of the return instruction to record the sum value corresponding to the return instruction.

For example, when the electronic device 3 receives a transmission instruction with a transmission index value ADC_R, the electronic device 3 may correspondingly provide a return instruction. The return instruction may have a header field, an instruction length field, a third field, a signature field, and a checksum field. The header field may record the transmission index value ADC_R in the length of one byte. The instruction length field may record the instruction length value in the length of one byte. The third field may record a plurality of pieces of ADC read data, and each piece of ADC reading data has a length of four bytes. First ten bits of each piece of ADC read data record the converted data, and the seventeenth to twenty-fourth bits of each piece of ADC read data correspond to eight ADC transmission ports. The signature field may record the signature value SV in the four bytes. The checksum field may perform summing based on the data of the return instruction to record the sum value corresponding to the return instruction.

For example, when the electronic device 3 receives a transmission instruction with a transmission index value SPI_R, the electronic device 3 may correspondingly provide a return instruction. The return instruction may have a header field, an instruction length field, a third field, a signature field, and a checksum field. The header field may record the transmission index value SPI_R in the length of one byte. The value of the transmission index value SPI_R may be, for example, 0x04 or 0x06 to correspond to the read SPI transmission port. The instruction length field may record the instruction length value in the length of one byte. The third field may record the read data, and the byte length of the read data may be adjusted according to the read length value SPI_RL in the transmission instruction provided by the host-side device 2. The signature field may record the signature value SV in the four bytes. The checksum field may perform summing based on the data of the return instruction to record the sum value corresponding to the return instruction.

Therefore, the connection device 1 may receive transmission instructions of different formats provided by the host-side device 2 upon configuration setting, to communicate with the electronic device 3 according to the control of the host-side device 2 through identifying the transmission instruction. In other words, connection device 1 can integrate transmission instructions of different formats provided by the host-side device 2 to perform read or write operations with the corresponding electronic device 3, so as to effectively integrate the plurality of different connection transmission formats during communication between the host-side device 2 and the electronic device 3, thereby improving compatibility of the host-side device 2.

Based on the above, the host-side device may be connected to the connection device through the human interface device transmission protocol of the universal serial bus, and then connected to a plurality of electronic devices with different connection transmission formats, so that the host-side device can communicate with different connection transmission formats. The host-side devices of different operating systems can configure the electronic devices of different connection transmission formats through the connection device with the configuration instruction of the unified packet format, and then perform communication through the transmission instruction, so that the connection device can effectively improve the compatibility between the host-side device and the electronic device.

What is claimed is:

1. A connection device adapted to be connected between an electronic device and a host-side device, the connection device comprising:
a plurality of transmission ports adapted to be connected to the electronic device;
a memory storing a lookup table, wherein the lookup table records a plurality of transmission format numbers, wherein the transmission format numbers respectively correspond to a plurality of transmission formats; and
a controller electrically connected to the transmission ports and the memory, wherein the host-side device generates, according to a host-side lookup table stored in the host-side device, at least one configuration instruction for communication, and the controller receives the at least one configuration instruction from the host-side device when at least one of the transmission ports connects the host-side device to the electronic device, wherein the at least one configuration instruction comprises a first field and a second field, wherein the first field records a transmission format index value, and the second field records selection information, wherein the controller searches the lookup table according to the transmission format index value to obtain a connection transmission format from the transmission formats, selects the corresponding at least one of the transmission ports from the transmission ports according to the selection information, and performs configuration setting on the electronic device according to the connection transmission format.

2. The connection device according to any of claims 1, wherein the host-side device communicates with the connection device according to a human interface device transmission protocol of a universal serial bus.

3. The connection device according to claim 1, wherein the controller compares the transmission format index value with the transmission format numbers to select, from the transmission formats, the connection transmission format for connection to the electronic device.

4. The connection device according to any of claims 3, wherein the host-side device communicates with the connection device according to a human interface device transmission protocol of a universal serial bus.

5. The connection device according to claim 3, wherein the transmission formats comprise a general-purpose input/output (GPIO) format, an inter-integrated circuit bus (I²C) format, a pulse width modulation (PWM) format, a serial peripheral interface (SPI) format, or an analog to digital converter (ADC) format.

6. The connection device according to any of claims 5, wherein the host-side device communicates with the connection device according to a human interface device transmission protocol of a universal serial bus.

7. The connection device according to claim 1, wherein the at least one configuration instruction further comprises a header field, an instruction length field, a signature field, and a checksum field, wherein the header field records a configuration index value corresponding to the at least one configuration instruction, wherein the controller searches the lookup table according to the configuration index value to obtain a configuration instruction format, the instruction length field records an instruction length value of the at least one configuration instruction, the signature field records a signature value, wherein the controller authenticates the at least one configuration instruction according to the signature value, and the checksum field records a sum value of all bit data in the at least one configuration instruction, wherein the controller debugs the at least one configuration instruction according to the sum value.

8. The connection device according to any of claims 7, wherein the host-side device communicates with the connection device according to a human interface device transmission protocol of a universal serial bus.

9. The connection device according to claim 1, wherein the memory stores a plurality of transmission numbers, wherein the transmission numbers respectively correspond to a plurality of transmission functions, wherein
after the controller receives the at least one configuration instruction, the controller communicates with the electronic device according to a transmission instruction received by the host-side device, wherein the transmission instruction comprises a header field and a third field, wherein the header field records a transmission index value according to a transmission instruction, and the third field records transmission information, wherein the controller queries the lookup table according to the transmission index value to obtain a connection transmission function from the transmission functions and communicates with the electronic device and performs the connection transmission function according to content of the transmission information.

10. The connection device according to any of claims 9, wherein the host-side device communicates with the connection device according to a human interface device transmission protocol of a universal serial bus.

11. The connection device according to claim 9, wherein the transmission instruction further comprises an instruction length field, a signature field, and a checksum field, wherein the header field records the transmission index value corresponding to the transmission instruction, wherein the controller searches the lookup table according to the transmission index value to obtain a connection transmission instruction format, the instruction length field records an instruction length value of the transmission instruction, the signature field records a signature value, wherein the controller authenticates the transmission instruction according to the signature value, and the checksum field records a sum value of all bit data in the transmission instruction, wherein the controller debugs the transmission instruction according to the sum value.

12. The connection device according to any of claims 11, wherein the host-side device communicates with the connection device according to a human interface device transmission protocol of a universal serial bus.

13. A connection device adapted to be connected between an electronic device and a host-side device, the connection device comprising:
a plurality of transmission ports adapted to be connected to the electronic device;
a memory storing a lookup table, wherein the lookup table records a plurality of transmission numbers, wherein the transmission numbers respectively correspond to a plurality of transmission functions; and
a controller electrically connected to the transmission ports and the memory, wherein the host-side device generates, according to a host-side lookup table stored in the host-side device, at least one transmission instruction for communication, and the controller receives the at least one transmission instruction from the host-side device to communicate with the electronic device when at least one of the transmission ports connects the host-side device to the electronic device, wherein the at least one transmission instruction comprises a header field and a first field, wherein the header field records a transmission index value according to a transmission instruction, and the first field records transmission information, wherein the controller queries the lookup table according to the transmission index value to obtain a connection transmission function from the transmission functions and communicates with the electronic device and performs the connection transmission function according to content of the transmission information.

14. The connection device according to claim 13, wherein the host-side device communicates with the connection device according to a human interface device transmission protocol of a universal serial bus.

15. The connection device according to claim 13, wherein the at least one transmission instruction further comprises an instruction length field, a signature field, and a checksum field, wherein the header field records the transmission index value corresponding to the at least one transmission instruction, the instruction length field records an instruction length value of the at least one transmission instruction, the signature field records a signature value, wherein the controller authenticates the at least one transmission instruction according to the signature value, and the checksum field records a sum value of all bit data in the at least one transmission instruction, wherein the controller debugs the at least one transmission instruction according to the sum value.

16. The connection device according to claim 15, wherein the host-side device communicates with the connection device according to a human interface device transmission protocol of a universal serial bus.
